(19) United States
(12) Patent Application Publication
(10) Pub. No.: US 2006/0230655 A1
(43) Pub. Date: Oct. 19, 2006

(54) Dynamic display air inflatable device

(76) Inventor: William Machala, Smithfield, RI (US)

Correspondence Address: MORGAN & FINNEGAN, L.L.P., 3 World Financial Center, New York, NY, 10281-2101, US

(21) Appl. No.: 11/400,127

(22) Filed: Apr. 6, 2006

Related U.S. Application Data
(63) Continuation-in-part of application No. 11/127,490, filed on May 11, 2005.
(60) Provisional application No. 60/630,530, filed on Nov. 23, 2004.

(51) Int. Cl. G09F 19/00

(52) U.S. Cl. 40/410

(57) ABSTRACT

The invention is directed to an inflatable display that has a plurality of inflation modules. The modules are inflated by a fan element. More specifically, a first inflation module is formed from a permeable material and configured to represent a predetermined shape or design when inflated, such as a snowman, Santa Claus, Easter Bunny, Uncle Sam or another seasonal or holiday character. The first inflation module is surrounded by a non-permeable material creating an enclosure around the first inflation module and forming a second inflation module. The first inflation module is formed with at least one exhaust port in its base, which has two purposes. First, the exhaust port acts to inflate the second inflation module. Second, the exhaust port in the first inflation module acts in coordination with an exhaust port formed in the surface of the second inflation module to create an airflow that agitates a plurality of “snowlike” particles within the second module, or particles corresponding to any holiday and/or seasonal display. A vacuum blowing tube with particle inlet and outlet portions can facilitate the agitation of particles within the enclosure. Moreover, an anti-static device can be added to the vacuum blowing tube to prevent the static clinging or lumping together of particles as they pass through the vacuum blowing tube. In addition, the exhaust ports can be arranged in a manner to cause the particles to move in a swirling manner within the second inflation module. The first inflation module can also be configured to rotate within the second inflation module, or to to have more than one inflatable compartment to achieve an animating effect.

This is continuation-in-part of co-pending application Ser. No. 11/127,490, filed May 11, 2005, entitled DYNAMIC DISPLAY AIR INFLATABLE DEVICE filed in the name of William Machala, to which priority under 35 U.S.C. §120 is claimed, and the entirety of which is incorporated by reference herein. The co-pending application claims priority from U.S. provisional Patent Application Ser. No. 60/630,530 entitled DYNAMIC DISPLAY FORMED WITHIN AN INFLATABLE filed in the name of William Machala on Nov. 23, 2004, the entirety of which is incorporated by reference herein.

### FIELD OF THE INVENTION

The apparatus and method of the present invention relate to dynamic inflatable air displays that may be formed within a transparent enclosure and inflated through the use of a fan or other inflation device.

### BACKGROUND OF THE INVENTION

Inflatable displays have become increasingly popular in recent years. These types of displays have a wide range of application, shape and size, including, but not limited to, figures for holiday and seasonal decoration, marketing, advertising, entertainment, and event attraction. The inflatable displays are made from a permeable fabric that allows air to pass through the fabric at approximately the same rate as the air being blown into the inflatable display. The process of continuously blowing air being supplied from a fan or other inflation device occurring at substantially the same rate as air escaping the fabric allows the display to maintain a three-dimensional shape without the use of an internal or external frame or structure. These are known in the industry as “cold-air” inflatable displays.

Typically, the cold-air inflatable display is a static figure formed from an inflation module which represents an individual figure when inflated. For example, a consumer may decide to decorate their house with a jack-o-lantern inflatable display for the Halloween season, a snowman inflatable display for the holiday season, or an Uncle Sam inflatable display for Independence Day. However, the inflatable display is generally a static element that is representative of a holiday or seasonal display. As such, typically, a figure is inflated to form a static display. There is no present apparatus or method utilizing a fan element or other inflation element to inflate an inflation module provided within an enclosure, wherein the fan element, the enclosure and the inflation module provide a dynamic display, as described herein.

### SUMMARY OF THE INVENTION

The invention is directed to an inflatable display that has a first inflation module formed within a transparent enclosure. The inflation module is inflated by a fan element. More specifically, a first inflation module is formed from a permeable material and configured to represent a predetermined shape or design when inflated, such as a snowman, Santa Claus, Easter Bunny, Uncle Sam or any other type of holiday or seasonal display scene. The first inflation module is surrounded by a non-permeable material creating an enclosure forming a second inflation module.

According to an embodiment of the invention, a first inflation module is inflated in the shape of a snowman or other holiday or seasonal figure. The first inflation module is formed with at least one exhaust port in its base, which has two purposes. First, the exhaust port acts to inflate the second inflation module. Second, the exhaust port in the first inflation module acts in coordination with an exhaust port formed in the surface of the second inflation module to create an air flow within the enclosure. The second inflation module includes a plurality of small particles that are formed to look like snow or any other dynamic particles or objects appropriate for a holiday or seasonal display scene. Furthermore, the particles are created from a very light material and are carried by the air flows within the enclosure. Accordingly, an observer looking at the invention would visualize a snowing environment surrounding a snowman.

According to another embodiment of the invention, at least one vacuum blowing tube is associated with at least one exhaust port for directing and circulating the plurality of small particles within the enclosure of the inflatable display. The vacuum blowing tube having a particle inlet whereby particles are caused to enter the vacuum blowing tube by a vacuum created by air flowing through the tube and a particle outlet for directing the discharge and circulation of the particles within the enclosure. The vacuum blowing tube preferably includes an antistatic device affixed to the tube, preferably made from a conductive material such as silver oxide, to prevent particles from gathering or clinging together from the generation of static electricity as they enter and pass through the tube.

In yet another embodiment of the invention, the first inflation module can be configured to move within the enclosure. In one such embodiment, a mobile first inflation module is mounted for circulation upon a rotating turntable positioned within the enclosure.

In still another embodiment, the first inflation module comprises multiple inflation compartments. In one such embodiment, a first compartment is inflated by a first fan element. The first compartment is operatively connected to a second inflatable compartment. For example, the second inflatable compartment may be situated within the first compartment. A second fan element is associated and configured to inflate the second compartment. The second compartment may be periodically inflated and deflated by turning the second fan element on and off.

In another alternative of the invention, the exhaust port or ports formed on the surface of the first inflation module can be positioned in any manner to direct the air flow circulation within the enclosure. For example, at least one exhaust port may be positioned within the base of the first inflation module in a manner to create a circulating or swirling air flow within the enclosure so that particles will circulate or swirl around the first inflatable module within the enclosure.

It will be appreciated by those skilled in the art that the foregoing brief description and the following detailed description are exemplary and explanatory of this invention, but are not intended to be restrictive thereof or limiting of the advantages which can be achieved by this invention. Thus, the accompanying drawings, referred to herein and constituting a part hereof, illustrate preferred embodiments of this invention, and, together with the detailed description, serve to explain the principles of this invention.

### BRIEF DESCRIPTION OF THE DRAWINGS

The features and advantages of the present invention, both as to its structure and operation, will be apparent from the following detailed description, especially when taken in conjunction with the accompanying drawings, wherein:

FIG. 1 is a side view of an embodiment of the present invention illustrating a snowman as the first inflation module enclosed within a transparent plastic material creating a second inflation portion.

FIG. 2 illustrates three exemplary embodiments of polystyrene particles for use with the present invention.

FIGS. 3A-3E are a series of views illustrating the inflation process according to an embodiment of the invention.

FIG. 4 is an embodiment of the invention illustrating air flow progression from a fan element introducing air into the inflatable device to the air escaping from the inflatable device through a mesh screen formed in the enclosure.

FIG. 5 illustrates another embodiment of the invention illustrating an air flow progression from a fan element introducing air into the inflatable device to air escaping the inflatable device through a mesh screen formed in the enclosure.

FIG. 6 illustrates another embodiment of the invention including a vacuum blowing tube for circulating particles within the enclosure.

FIG. 7 illustrates a magnified view of an embodiment of the vacuum blowing tube.

FIG. 8 illustrates an anti-static device associated with the vacuum blowing tube.

FIG. 9 is another embodiment of the invention illustrating a mobile first inflation module mounted for circulation upon a rotating turntable positioned within the enclosure.

FIG. 10 illustrates the assembly of a mobile first inflation module upon a rotating turntable.

FIG. 11 is a front perspective view of an embodiment of the invention illustrating a multiple compartment inflatable display with a second compartment in a deflated state positioned within the enclosure.

FIG. 12 is a rear perspective view of an embodiment of the invention illustrating a multiple compartment inflatable display with a second compartment in a deflated state positioned within the enclosure.

FIG. 13 is a front perspective view of an embodiment of the invention illustrating a multiple compartment inflatable display with a second compartment in an inflated state positioned within the enclosure.

FIG. 14 is a rear perspective view of an embodiment of the invention illustrating a multiple compartment inflatable display with a second compartment in an inflated state positioned within the enclosure.

FIG. 15 is an embodiment of the invention illustrating exhaust ports configured for blowing particles in a swirling manner within the enclosure.

### DETAILED DESCRIPTION OF THE INVENTION

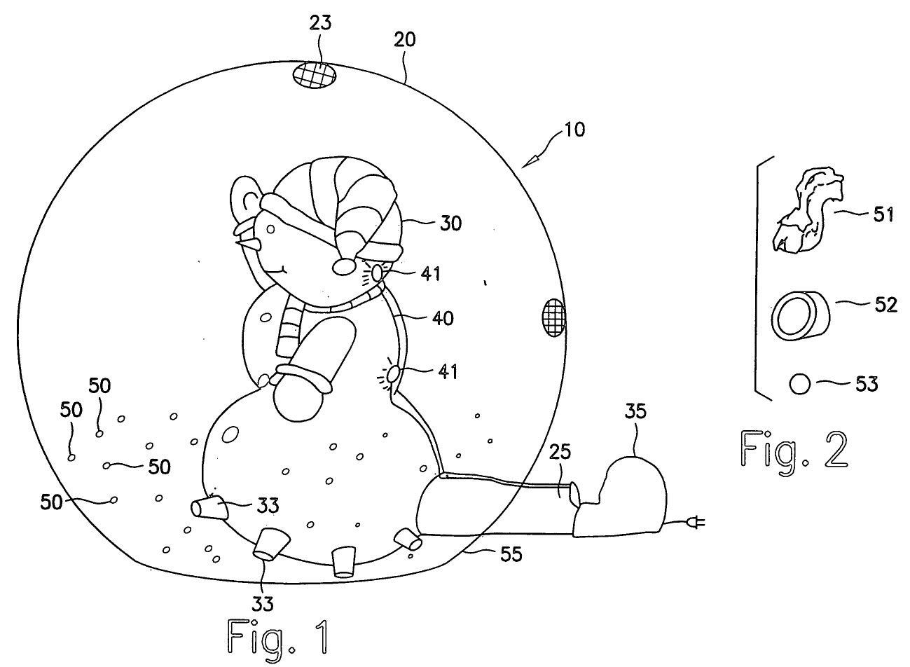

The apparatus and method of the present invention will now be discussed with reference to FIGS. 1, 2, 3A-3E and 4-15. As first illustrated in FIG. 1, the invention is directed to an inflatable display unit 10. More specifically, according to an embodiment of the invention, inflatable display unit 10 will be discussed herein with regard to its component pieces that include first inflation module 30, enclosure 20 (second inflation module), fan element 35, lighting apparatus 40, and “snowflake” particles 50. An object of the invention is to implement first and second inflation modules, wherein the first is disposed within the second module. Furthermore, the second module is formed from a clear plastic material creating an enclosed operational environment. According to the invention, the air used to inflate the first and second modules is also used to agitate a plurality of polystyrene particles within the enclosure. Accordingly, an observer viewing the inflatable display would get the impression that it is snowing within the enclosure.

As illustrated according to one embodiment of the invention, first inflation module 30 is shown in the figures as a snowman. It is to be understood that while the figures illustrate a snowman, first inflation module 30 may be configured in any character, shape or size, depending on the specific need and purpose of the display. By way of example only, alternate embodiments of the invention may include such characters as Santa and/or Mrs. Clause, a reindeer, an Easter Bunny, Uncle Sam, or any type of seasonal or holiday character. Furthermore, it is to be understood that any number of inflation modules may be utilized to create the display and that any number or variety of inner-modules may be configured within one or more outer modules. Any number of fans corresponding to the number of inflation modules may also be utilized. In alternative embodiments, the inflatable device may include an inflatable city skyline or other tourist attraction that would parallel the typical liquid filled “snow globes” that are often sold to tourists.

First inflation module 30 is preferably made from a permeable fabric that allows air to escape at approximately the same rate as air being blown into the inflatable display 10 by fan element 35. Inflatable display 10 is held in position by a securing mechanism, such as, a ballast 55 situated at the bottom of enclosure 20 or a tether that fastens to either the ground or another structure and is secured to said inflatable display 10 by securing devices, such as a securing ring attached to inflatable display 10.

The inflatable display may include an interior lighting arrangement 40 that includes one or more light bulbs 41 secured to a power cord and disposed within first inflation module 30. Protective covers are secured around each light bulb 41 to protect the permeable fabric of first inflation module 30 from heat produced from each light bulb 41. Interior lighting assembly 40 is attached to fan assembly 35 through an electrical connector on the bottom end of a power cord that mates with fan assembly 35. Advantageously, if an operator does not want to illuminate the interior of the display, the operator may simply detach the electrical connector from the fan assembly element to remove power from interior lighting arrangement 40, without necessarily removing lights 41 from the interior of the display.

As illustrated as reference character 50 in FIG. 1, “snowflake” particles may be formed as polystyrene particles, or a number of other light compact polymers. Polystyrene is discussed as a preferred embodiment because it is easily produced and readily available. More specifically, polystyrene is a strong plastic created from erethylene and benzene that can be injection molded, extruded or blow molded into any number of shapes and sizes. By way of example only, FIG. 2 illustrates three exemplary embodiments of the polystyrene implemented to represent the snowflakes.

However, it is to be understood that a wide variety of shapes/sizes of particles may be utilized corresponding to the holiday and/or seasonal display and based on design characteristics that include the size of the enclosure and/or the size/shape and configuration of the first inflation module or the size and power characteristics of the fan element in a given implementation. For example as shown in FIG. 2, in order to maximize the visual effect, packing peanuts 51 (the well-known filler used to fill and protect packages from being damaged during shipping) which are large oblong shaped pieces of polystyrene may be used. Alternatively, a smaller scale implementation may use hollow semi-spherical shaped polystyrene pieces 52 or even simple polystyrene pellets 53. The embodiments discussed herein are illustrative of possible implementations and a wide variety of shapes and sizes of polystyrene particles, or any other type of compact light particle may be implemented to represent very light particles, such as “snowflakes” 50.

As illustrated in FIG. 1, fan element 35 is preferably implemented as a lightweight plastic sleeveless bearing fan. The lightweight of the electric fan assembly and the plastic housing enables the fan assembly to be secured to the fabric of the inflatable display at a position elevated above the surface-touching bottom of the display without distorting the shape of inflatable display 10. Moreover, such an assembly inflates device 10 without the need for a base to support and elevate the fan above the ground to achieve sufficient air intake. Advantageously, fan element 35 can be easily removed from its respective housing for cleaning or replacement whenever necessary. Fan element 35 is covered with a safety grill to guard against unwanted debris from entering the display as well as contacting fan blades. Further, it is possible for fan element 35 to be configured with a variable air speed control, which provides a consumer the ability to adjust the degree of snowflake agitation. Also, depending on the actual implementation, the fan element may be configured with a stand that raises the fan element off of the ground.

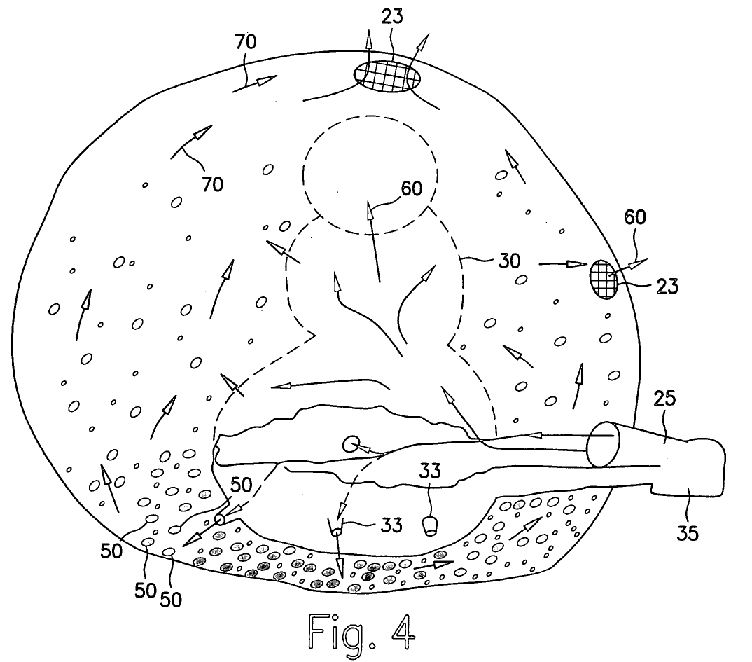

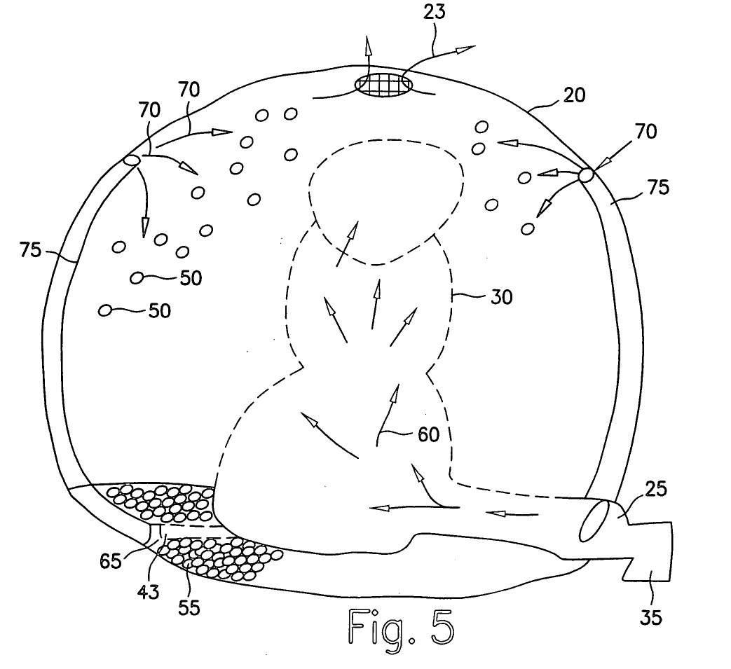

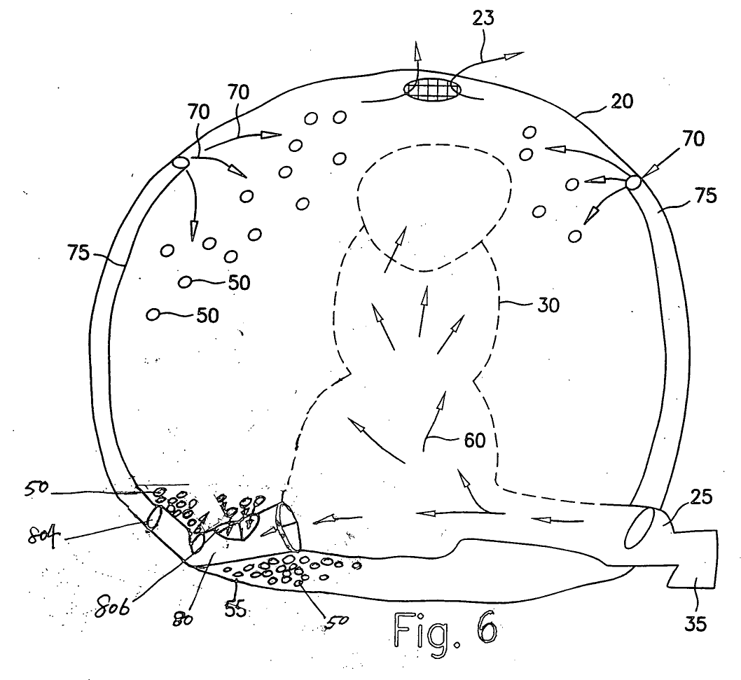

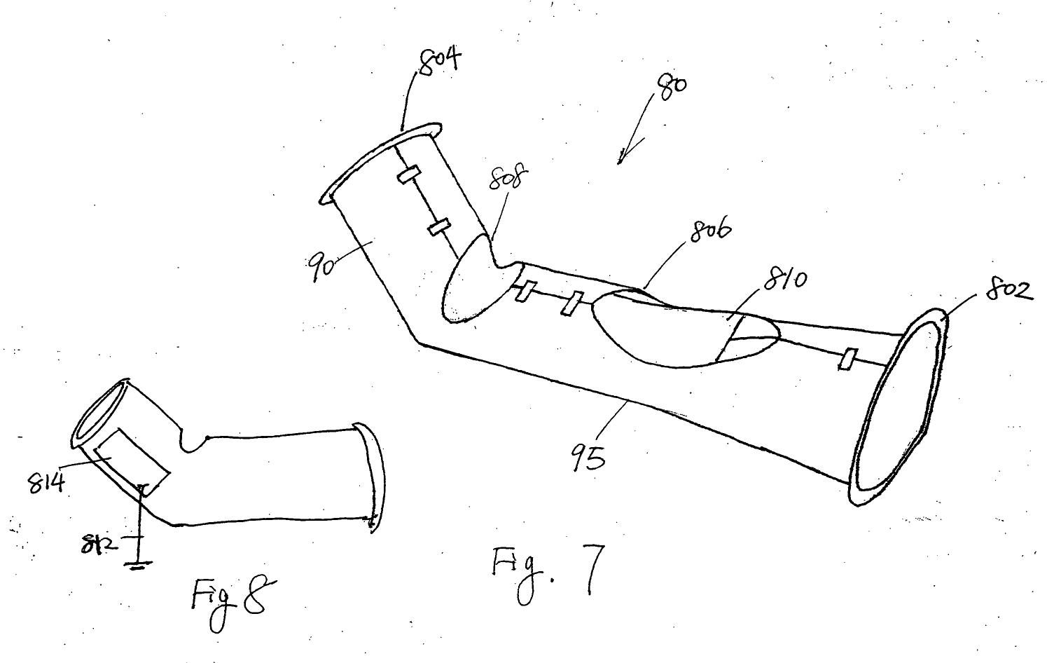

Furthermore, as illustrated in FIG. 1, inflatable display 10 includes second inflation module 20 that creates a transparent enclosure around first inflation module 30. As shown, second inflation module 20 forms a transparent hollow sphere with an aperture allowing air intake tube 25 to connect first inflation module 30 with fan element 35. Second inflation module 20 is formed with at least one exhaust port 23. As illustrated in FIG. 1, exhaust port 23 is formed as a circular mesh screen. In order to prevent rain from entering enclosure 20, while maintaining the position of exhaust port 23, an air duct may be attached to the exterior side of exhaust port 23 at the top of the enclosure. The exhaust port 23 can also be placed on the side of the second inflatable module 20 to prevent rain or falling leaves from entering the inflatable device 10. The functionality of exhaust port 23 will be discussed in greater detail below with regard to FIG. 4. It is to be understood that depending on the actual implementation, the size, shape, configuration and number of exhaust ports 23 formed in the surface of second inflation module 20 may vary based on characteristics such as size of the second inflation module, the flow rate of air blown into inflatable device 10 by fan element 35, or any other number of design considerations.

Similarly, first inflation module 30 also has at least one exhaust port 33. As shown in FIG. 1, exhaust port 33 is formed in the base of first inflation module 30 to both agitate particles 50, as well as inflate second inflation module 20. Exhaust port 33 may be fitted with a screen in order to keep particles 50 from entering first inflation module 30. It is to be understood that the size, shape, configuration, and placement on the surface of first inflation module 30 may vary between implementations.

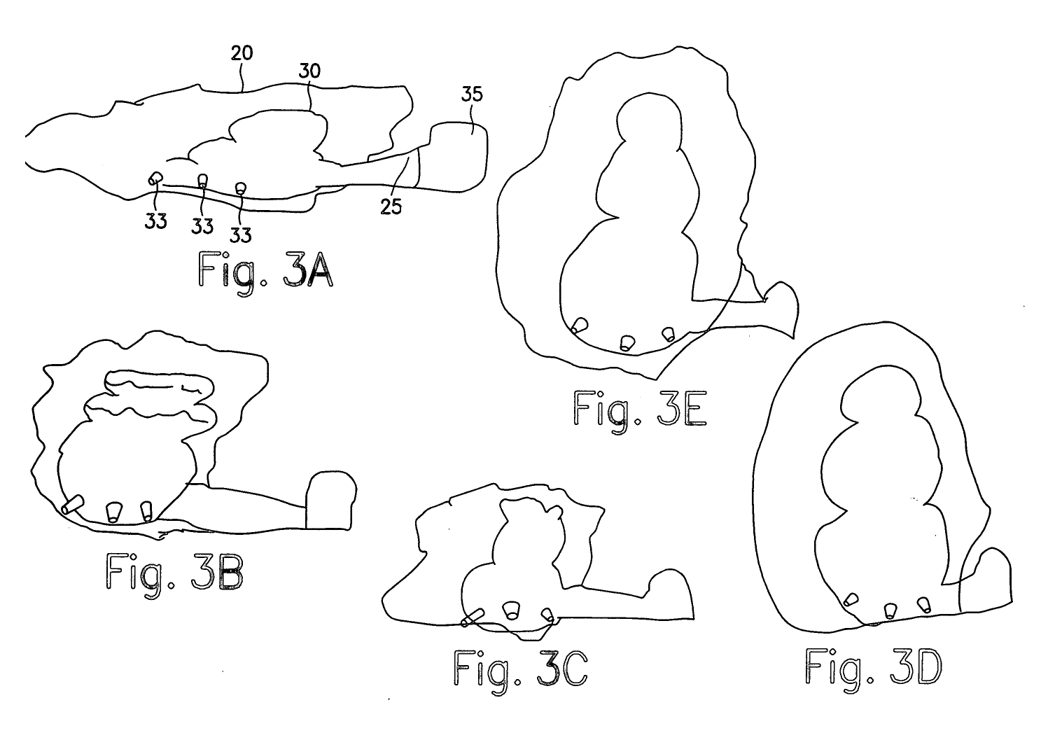

FIGS. 3A-3E illustrate the process of inflating inflatable device 10. As discussed above, fan element 35 forces air through air intake tube 25 into first inflation module 30. Because first inflation module 30 is made from a permeable material, air may leak from first inflation module 30 into second inflation module 20. Furthermore, first inflation module 30 is configured with at least one exhaust port 33 formed near the base of the module (FIGS. 3A-3E illustrate an exemplary embodiment of the invention implementing three exhaust ports), wherein exhaust port 33 directs a portion of the air from intake tube 25 directly into second inflation module 20.

FIG. 4 illustrates an air flow progression from a point in time wherein a fan element introduces air into the inflation device to a point in time wherein the air escapes through an exhaust valve formed in the enclosure according to an embodiment of the invention. For the purpose of illustration, the arrows with solid arrowheads 60 represent airflows either within first inflation module 30 or outside second inflation module 20, whereas arrows with hollow arrowheads 70 represent airflows within enclosure 20, but outside first inflation module 30.

Air is introduced from fan element 35, through air intake tube 25 and into first inflation module 30. The air enters second inflation module 20 primarily through exhaust port 33, but also to a lesser extent though the permeable surface of first inflation module 30. Although particles 50 are made of a light material, they are heavier than air and therefore accumulate around the base of the exterior of first inflation module 30. Accordingly, by configuring exhaust ports 33 around the base of the first inflation module, particles 50 are easily agitated by air exiting exhaust port 33.

Furthermore, second inflation module 20 has at least one exhaust port 23 formed at the top and/or the back of the enclosure. As discussed above, the second inflation module is formed from a non-permeable material. Accordingly, exhaust port 23 and exhaust port 33 act to create air flows within the enclosure. These airflows agitate the polystyrene particles that have accumulated around the base of enclosure 20 and guide them toward the top of the enclosure, where the particles subsequently fall back toward the base. The continuous airflow agitation/guiding process creates an effect that generates the impression of a snowfall to an observer watching inflated device 10 in operation.

FIG. 5 illustrates an air flow progression within another embodiment of the invention wherein exhaust ports 33 formed in the base of first inflation module 30 are replaced with vacuum agitation ports 43. Air is introduced into the inflatable device via fan element 35 and air duct 25. The air inflates first inflation module 30 and then continues into a vacuum agitation port 43. The vacuum agitation port 43 directs the air flow into particle reservoir 55. Particle reservoir 55 collects particles after they have been agitated, as well as feeds agitation guide 75. Vacuum port 43 works in coordination with agitation guide 75 to bring the particles from particle reservoir 55 to the top of second inflation module 20 to dispersal point 70.

FIG. 6 illustrates another embodiment of the invention wherein an elbow-shaped vacuum blowing tube 80 is associated with exhaust port 33 formed in the base of first inflation module 30. Air flow is introduced into the inflatable device via fan element 35 and air duct 25. The air flow inflates first inflation module 30 and then continues into vacuum blowing tube 80. The air flow into vacuum blowing tube 80 creates a vacuum proximate particle inlet 806 on vacuum blowing tube 80. Particles 50 gathered at reservoir 55 are caused to enter into vacuum blowing tube 80 through particle inlet 806 by the vacuum. Vacuum blowing tube 80 functions in coordination with agitation guide 75 to circulate particles from dispersal point 70 within the enclosure. Solid arrowheads in FIG. 6 represent air flow within first inflation module 30 and second inflation module 20, whereas hollow arrowheads represent circulation of particles 50 within the enclosure. Any configuration of vacuum blowing tube 80 with or without agitation guide 75 for circulation of particles within the inflation device is suitable for use within the invention.

FIG. 7 illustrates a magnified view of elbow-shaped vacuum blowing tube 80. Vacuum blowing tube 80 has inlet portion 95 and outlet portion 90 which are oriented at an angle to each other in an elbow configuration. Inlet portion 95 and outlet portion 90 may be positioned at any angle relative to each other that is suitable for use in the invention. Vacuum blowing tube 80 has air inlet 802 and particle outlet 804 on each end as shown in FIG. 7. Air inlet 802 is connected to first inflation module. Particle outlet 804 may be connected to agitation guide 75. Particle inlet 806 is shown on inlet portion 95 in FIG. 7. Particle inlet 806 has sloping entrance 810 into interior of inlet portion 95. Air flow is introduced into first inflation module via fan element 35 and air duct 25 and continues into vacuum blowing tube 80 through opening 802. When air enters tube 80, it creates a vacuum proximate particle inlet 806. Particles 50 gathered at particle reservoir 55 are forced to enter particle inlet 806 by the vacuum. Slope entrance 810 directs the particles into tube 80 which are then blown by the air flow within the tube through particle outlet 804 and agitation guide 75 to dispersal point 70 positioned in the upper portion of second inflation module 20. Since outlet portion 90 of tube 80 is positioned at an angle to inlet portion 95, particles that strike the interior bottom wall of outlet portion 90 may be directed backward creating an inverse flow of particles. The inverse flow of particles could counteract and reduce air and particle flow. However, opening 808 on the top surface of outlet portion 90 as shown in FIGS. 6 and 7, allows particles to be ejected from the tube through opening 808 to prevent reduction of air and particle flow.

As discussed above, particles 50 are preferably made from a polystyrene material. Such polystyrene particles tend to generate static electricity and stick or cling together. To prevent particles from sticking or clinging together, anti-static device 814 is affixed to tube 80, preferably to the bottom wall of outlet portion 90 of tube 80 as shown in FIG. 8. Anti-static device 814 is preferably made from a conductive material, such as, for example, silver oxide. Copper coded wire 812 grounds anti-static device 814. When particles 50 pass anti-static device 814, their static charge is discharged preventing particles from sticking or clinging together.

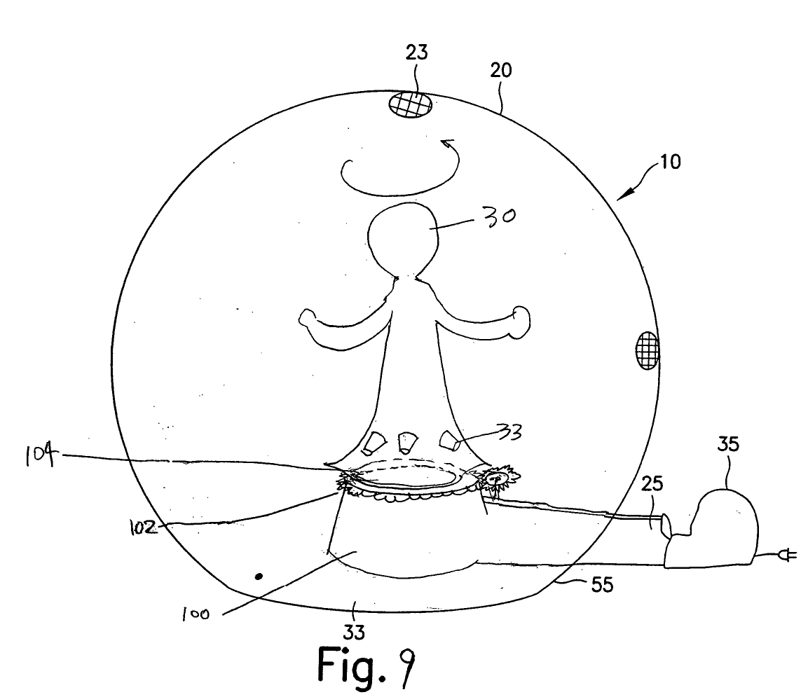

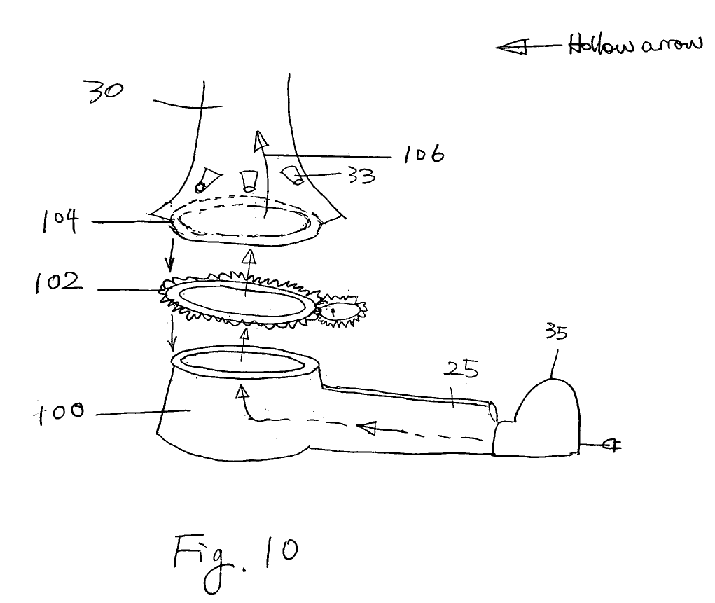

In another embodiment, first inflation module 30 can be configured to move within the enclosure. For example, first inflation module 30 can be positioned to rotate on a turntable as shown in FIG. 9, preferably a motor driven gear operated turntable. Any known machine operated base can be used in the invention for creating a mobile first inflation module. As shown in FIG. 9, supporting device 100 supports motor driven gear operated turntable 102. Passage ways through supporting device 100 are configured so that air flow passes through supporting device 100 to inflate first inflation module 30. First inflation module 30 is positioned on circular track 104 associated for rotation upon motor driven gear operated turntable 102. FIG. 10 illustrates the assembly of base 100, motor driven gear operated turntable 102 and circular track 104. Hollow arrows 106 illustrate the air flow from fan 35 through air intake tube 25, base 100, turntable 102 and circular track 104 to inflate first inflation module 30. The rotation of turntable 102 driving first inflation module 30 moves first inflation module 30 in a circular rotation within second inflation module 20.

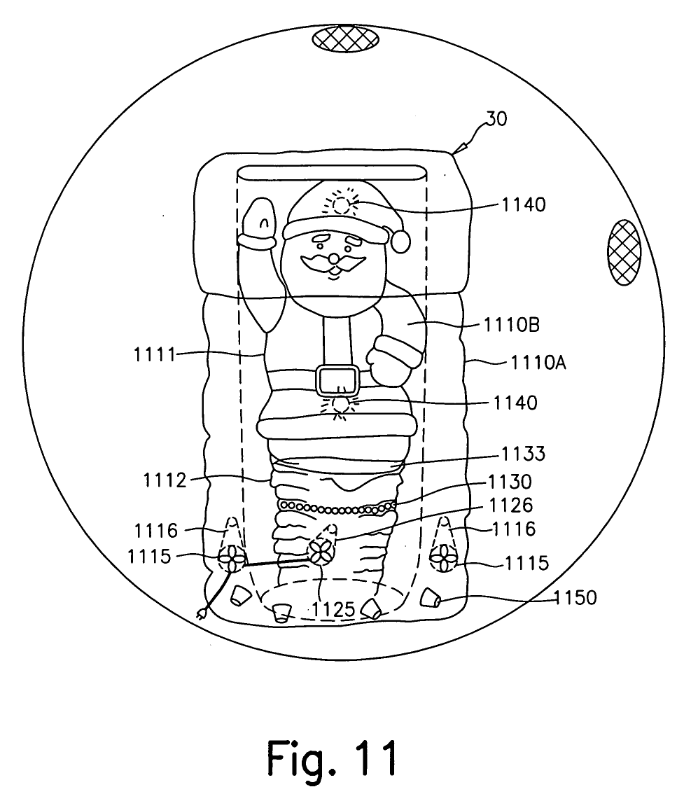

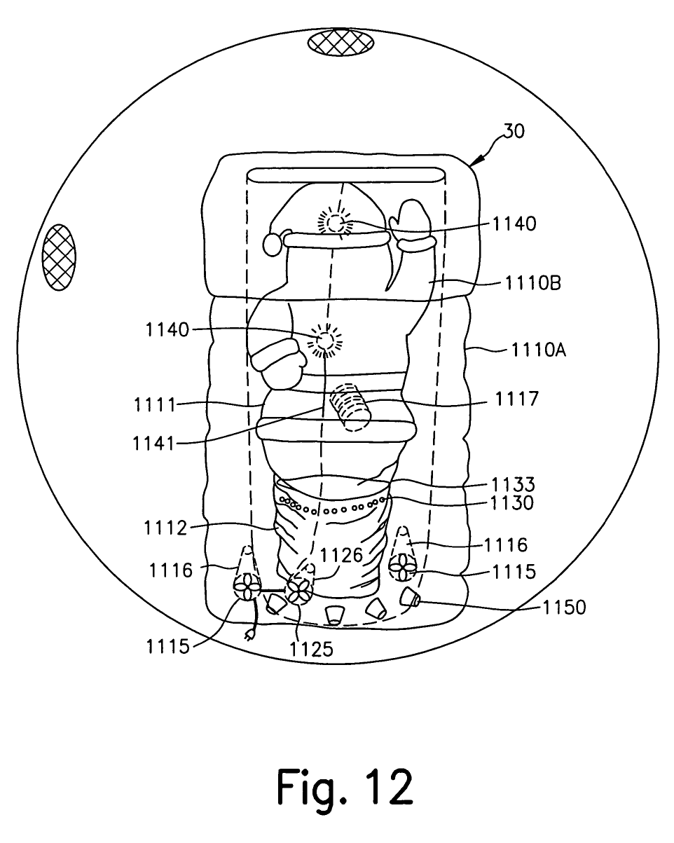

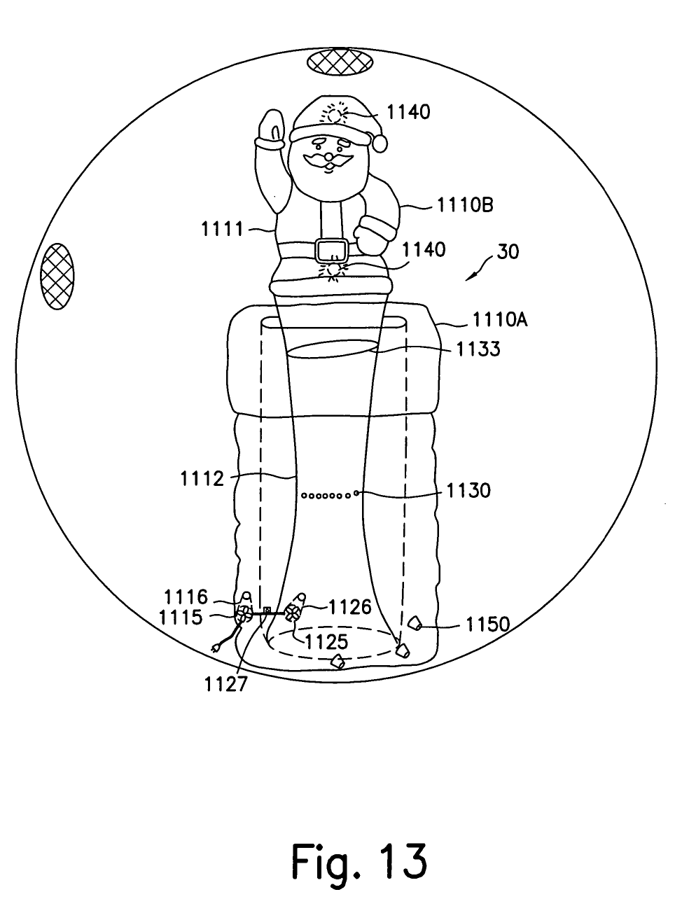

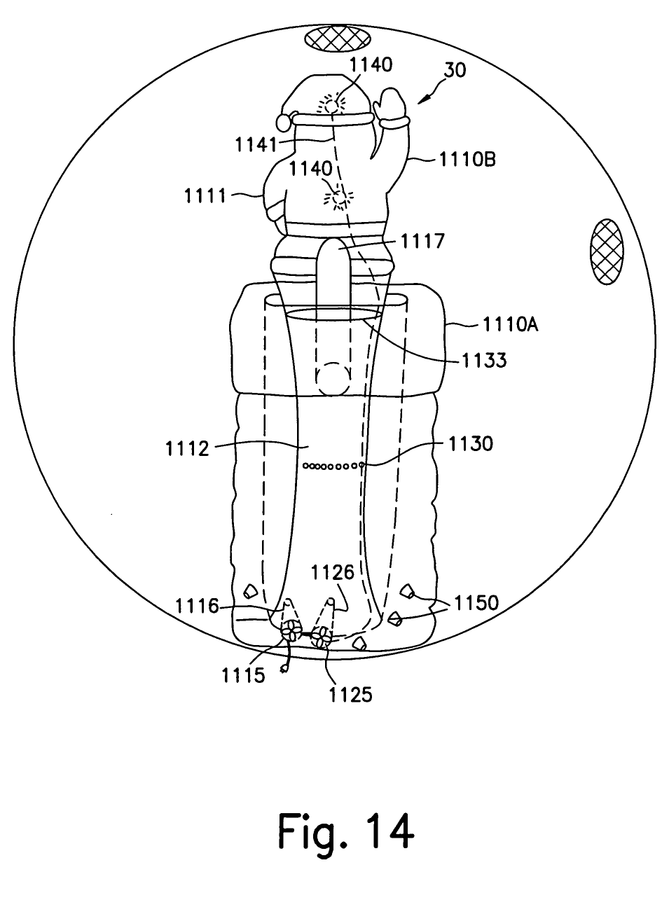

In still another embodiment, first inflation module 30 can be configured with multiple inflatable compartments as disclosed in Application Ser. No. 60/630,535, incorporated herein by reference. For example, the first inflation module 30 in FIGS. 11-14 is shown as comprising a first inflatable compartment (chimney) 1110A and a second inflatable compartment (Santa Claus) 1110B. FIGS. 11-12 illustrate a deflated second inflatable compartment 1110B. FIGS. 13-14 illustrate an inflated second inflatable compartment 1110B.

The inflatable display may include interior lighting arrangement 1141 (shown in FIGS. 12 and 14) that includes one or more light bulbs 1140 secured to a power cord. Protective covers are secured around each light bulb 1140 to protect the permeable fabric of inflation module 30 from heat produced from each bulb. Interior lighting arrangement 1141 is attached to fan assembly (1115 and 1125) through an electrical connector on the bottom end of a power cord that mates with fan assembly (1115 and 1125). Advantageously, if an operator does not want to illuminate the display, he/she may simply detach the electrical connector from the fan assembly element to remove power from interior lighting arrangement 1141, without necessarily removing lights from within the display.

As illustrated, fan elements 1115 and 1125 are preferably implemented as a lightweight plastic sleeveless bearing fan. The lightweight of the electric fan assembly and the plastic housing enables the fan assembly to be secured to the fabric of the inflatable display at a position elevated above the surface-touching bottom of the display without distorting the shape of the inflatable display and without the need for a base to support and elevate the fan above the ground to achieve sufficient air intake. Advantageously, fan elements 1115 and 1125 can be easily removed from their respective housings for cleaning or replacement whenever necessary. Fan elements 1115 and 1125 are covered with safety grills to guard against unwanted debris from entering the display as well as contacting fan blades 1130.

As illustrated in FIGS. 11-12, first inflatable compartment 1110A is inflated by fan element 1115 that is attached to compartment 1110A via an air intake tube 1116. Air intake tube 1116 may be made of the same material as inflation module 30, itself, and integrally formed as part of inflation module 30. Further, air intake tube 1116 may include fasteners on one end so that it is joined with fan element 1115. This allows the inflatable elements to be interchangeable, simply by attaching a different inflatable display 30 to fan assembly (1115 and 1125).

Fan element 1115 is responsible for maintaining first inflatable compartment 1110A in an inflated state. Further, second air intake tube 1117 is used to connect first inflatable compartment 1110A with portion 1111 of second inflatable compartment 1110B. For example, in the embodiment shown in FIGS. 11 and 12, portion 1111 is implemented as the body of Santa Claus. Second intake tube 1117 allows inflation module 30 to maintain portion 1111 in an inflated state so long as fan element 1115 is turned on. It is to be understood that depending on the actual implementation, the fan element may be configured in a manner such that it is raised above the ground, whether it is elevated by a stand or platform or by being fastened to a portion of the inflatable display.

Second air intake tube 1126 is fastened to second fan element 1125, in order to achieve an animating effect for inflation module 30. More specifically, second inflatable compartment 1110B is divided into two portions, static portion 1111 (the Santa Claus body 11) and dynamic inflation portion (extension portion 1112), separated by partition 1133. FIGS. 1I and 12 illustrate inflation module 30 in a first state, wherein second inflatable compartment 1110B is hidden within first inflatable compartment 1110A (and extension portion 1112 is un-inflated). In contrast, FIGS. 13 and 14 illustrate second inflatable compartment 1110B extending through an aperture in first inflatable compartment 1110A (extension portion 1112 is inflated).

Second inflatable compartment 1110B is divided into statically inflated portion 1111 and dynamically inflated portion 1112 (discussed above as the extension portion). Dynamically inflated portion 1112 is connected with air intake tube 1126 and consequently to fan element 1125. In order to actuate second inflatable compartment 1110B, power is periodically supplied to fan element 1125. Upon supplying power to fan element 1125, air is blown into dynamically inflatable portion 1112, which expands as it receives the air.

As shown in FIGS. 13 and 14, when air is introduced into dynamically inflatable portion 1112, static inflatable portion 11 rises into view and is no longer hidden. Dynamically inflatable portion 1112 is secured to the base of first inflatable compartment 1110B and is made from enough material, so that when in the inflated state, static inflatable portion 1111 passes through the aperture in the first inflatable compartment and is held in full view of an observer. If power is removed from fan element 1125, air escapes from dynamic inflatable portion 1112 through ventilating ports 1130. It is to be understood that the precise number, size, configuration of and form of ventilating ports 1130 may vary based on the needs and design of the embodiment. For example, the ventilating ports may be formed as holes formed in a lateral ring (as illustrated in the figures) in dynamic inflatable portion 1112. However, in other embodiments they may be formed as slits running lengthwise along an edge of the dynamic portion or they may take any other form that facilitates the effect of allowing the air in the dynamic portion to escape.

It is to be understood that during the periods of time when dynamic inflation portion 1112 is fully inflated, fan element 1125 is operated at a speed to overcome the effect of ports allowing air to escape. Also, depending on the application, it is to be understood that the frequency associated with supplying power to and removing power from fan element 1125 may be either predetermined by manufacturer or controlled by variable control switch 1127 attached to fan element (1115, 1125) assembly, as shown in FIG. 13. Moreover, as illustrated in FIGS. 12 and 14, the first inflation module 30 may include a string 1141 of lights 1140 that are disposed at intervals within first or second inflatable compartments (1110A/1110B).

It is to be understood that the invention is not limited to the multiple compartment first inflation module embodiment shown in FIGS. 11 through 14. For example, other embodiments may comprise any number, shape or size compartments and associated fan elements or any characteristic components corresponding to any holiday or seasonal display, such as a rabbit and an Easter egg, a witch and a caldron, or many others.

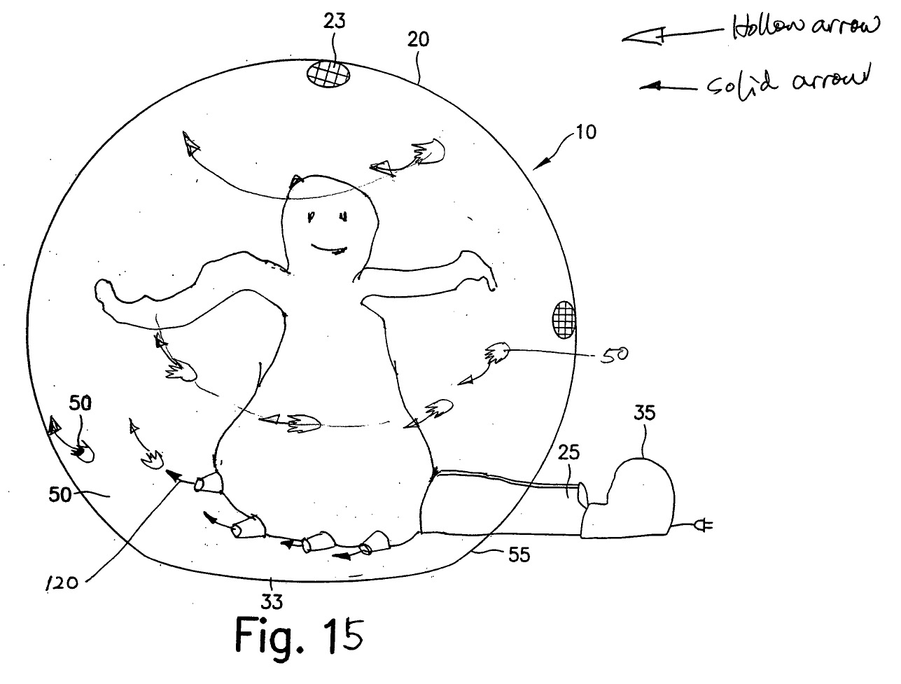

As shown in FIG. 15, exhaust port or ports 33 can be positioned in any manner to direct the air flow circulation within the enclosure. For example, in this embodiment, exhaust ports 33 are positioned within the base of first inflation module 30 in a manner to create a circulating or swirling air flow within the enclosure so that particles will circulate or swirl around the first inflation module within the enclosure. Specifically, the exhaust ports 33 are arranged in the same direction so that air flowing out of exhaust ports 33 creates a continued circular or swirling air flow within second inflation module 20. Solid arrow 120 illustrates the direction of air flowing out of exhaust ports 33. The air flow agitates particles 50 such that they travel around the first inflation module in a circular or swirling manner. By way of example, first inflation module 30 is in the shape of a ghost. Particles 50 are in the shape of leaves with yellow color. The yellow leaf-shaped particles swirling around a ghost creates an impression of Halloween to an observer watching the inflated device in operation. It is to be understood that depending on the actual implementation, size, shape, configuration, and the number and arrangement of exhaust ports 33 may vary based on characteristics such as the respective size of the first and second inflation modules, the air flow rate within the inflatable device 10, or any other number of design considerations.

Although illustrative preferred embodiments have been described herein in detail, it should be noted and will be appreciated by those skilled in the art that numerous variations may be made within the scope of this invention without departing from the principle of this invention and without sacrificing its chief advantages. The terms and expressions have been used as terms of description and not terms of limitation. There is no intention to use the terms or expressions to exclude any equivalents of features shown and described or portions thereof and this invention should be defined in accordance with the claims which follow.

1. An inflatable display comprising:
a first inflation module;
a second inflation module enclosing the first inflation module, wherein the second inflation module is transparent;
a fan element, operatively connected to the first inflation module;
a plurality of particles stored inside the second inflation module, but outside the first inflation module; and
a vacuum blowing tube connected to said first inflation module for circulation of said particles within said second inflation module.

2. The inflatable display of claim 1, further comprising an agitation guide configured within the second inflation module and connected to the vacuum blowing tube.

3. The inflatable display of claim 1, wherein the second inflation module includes an exterior exhaust port.

4. The inflatable display of claim 1, wherein the first inflation module is formed of a permeable material that is configured to assist in inflating the second inflation module.

5. The inflatable display of claim 1, wherein the vacuum blowing tube has an inlet portion and an outlet portion oriented at an angle to each other.

6. The inflatable display of claim 2, wherein the vacuum blowing tube has an inlet connected to the first inflation module and an outlet connected to the agitation guide.

7. The inflatable display of claim 1, wherein the vacuum blowing tube has a particle inlet.

8. The inflatable display of claim 1, wherein the vacuum blowing tube has an opening allowing particles to be ejected from the tube to prevent reduction of air and particle flow.

9. The inflatable display of claim 1, wherein the vacuum blowing tube further comprises an anti-static device.

10. An inflatable display comprising:
a first inflation module;
a second inflation module enclosing the first inflation module, wherein the second inflation module is transparent;
a turntable disposed for rotating the first inflation module within said second inflation module; and
a fan element, operatively connected to the first inflation module to provide continuous air flow to inflate the first and second inflation modules.

11. The inflatable display of claim 10, further comprising a plurality of particles stored inside the second inflation module but outside the first inflation module.

12. The inflatable display of claim 11, wherein the fan element provides a continuous air flow to inflate the first and second inflation modules and agitate the particles within the second inflation module.

13. The inflatable display of claim 10, wherein the second inflation module includes an exterior exhaust port.

14. The inflatable display of claim 10, wherein the turntable is motor driven and gear operated.

15. The inflatable display of claim 10, wherein the second inflation module includes an exterior exhaust port.

16. The inflatable display of claim 10, wherein the first inflation module is formed of a permeable material that is configured to assist in inflating the second inflation module.

17. An inflatable display comprising:
a first inflation module;
a second inflation module enclosing the first inflation module, wherein the second inflation module is transparent;
a fan element operatively connected to the first inflation module;
a plurality of particles stored inside the second inflation module, but outside the first inflation module; and
at least one exhaust port positioned on the first inflation module to agitate the particles to move in a swirling manner within the second inflation module upon activation of the fan element.

18. An inflatable display comprising:
a first inflation module having a first inflatable and a second inflatable compartment;
a second inflation module enclosing the first inflation module, wherein the second inflation module is transparent;
a first fan element providing a continuous air flow to inflate the first inflatable compartment and the second inflation module; and
a second fan element providing a periodic air flow to inflate and deflate the second inflatable compartment.

19. The inflatable display of claim 18, wherein the second inflatable compartment is configured with at least one ballast element.

20. The inflatable display of claim 18, wherein the second inflatable compartment is configured with at least one ventilating port.

21. The inflatable display of claim 18, wherein at least one illumination module is disposed within the first inflatable compartment.

22. The inflatable display of claim 21, wherein at least one illumination module is disposed within the second inflatable compartment.

23. The inflatable display of claim 22, wherein the illumination modules are operatively connected to one fan element.

24. The inflatable display of claim 18, wherein at least one of the fan elements includes an anchor extension portion.

25. The inflatable display of claim 19, wherein the ballast element is attached to a dynamic inflation portion of the second inflation compartment to assist in deflating the portion.

26. The inflatable display of claim 18, wherein the second fan element is configured to operate for an initial pre-determined length of time that is longer than a periodic operational airflow frequency.

27. The inflatable display of claim 18, wherein the second inflation module includes an exterior exhaust port.

28. The inflatable display of claim 18, wherein the first inflation module is formed of a permeable material that is configured to assist in inflating the second inflation module.

29. An inflatable display comprising:
a first inflation module having a first inflatable compartment and a second inflatable compartment;
a second inflation module enclosing the first inflation module wherein the second inflation module is transparent;
a plurality of particles stored inside the second inflation module, but outside the first inflation module;
a first fan element providing a continuous air flow to inflate the first inflatable compartment, the second inflation module and agitate the particles within the second inflation module; and
a second fan element providing a periodic air flow to inflate and deflate the second inflatable compartment.

30. An inflatable display comprising:
at least one inflatable compartment continuously inflated by a first fan element;
at least one inflatable compartment periodically inflated and deflated by a second fan element; and
an inflatable module enclosing the first inflatable compartment and the second inflatable compartment continuously inflated by the first fan element, wherein the inflatable module is transparent.
